(19) United States
(12) Patent Application Publication
(10) Pub. No.: US 2010/0021648 A1
(43) Pub. Date: Jan. 28, 2010

(54) COATING COMPOSITION FOR OPTICAL MEMBER, MANUFACTURING METHOD THEREOF, AND MANUFACTURING OF OPTICAL MEMBER

(75) Inventor: Hiroshi OTA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HOYA CORPORATION, Tokyo (JP)

(21) Appl. No.: 12/503,219

(22) Filed: Jul. 15, 2009

(30) Foreign Application Priority Data
Jul. 25, 2008 (JP) 2008-192538

(51) Int. Cl. C08F 2/48; C08G 59/00; C09D 7/00

(52) U.S. Cl. 427/508; 522/170; 522/79; 106/287.1

(57) ABSTRACT

A coating composition for optical member contains an epoxy group-containing compound, a photocationic polymerization initiator, an organic solvent, and inorganic particulates dispersed in the organic solvent.

### CROSS REFERENCES TO RELATED APPLICATIONS

The present invention contains subject matter related to Japanese Patent Application JP 2008-192538 filed in the Japanese Patent Office on Jul. 25, 2008, the entire contents of which being incorporated herein by reference.

### BACKGROUND OF THE INVENTION

1. Field of the Invention

The present invention relates to a coating composition for an optical member such a lens, a manufacturing method thereof, and a manufacturing method of an optical member using the coating composition.

2. Description of the Related Art

Recently, plastic has been substituting for inorganic glass to become mainstream as material for optical member, particularly as material for spectacle lens substrate, owing to its characteristics such as light weight, excellent impact resistance and the like.

The most widely used materials for manufacturing plastic lenses include, for example, allyl diglycol carbonate (hereinafter referred to as “CR-39”).

Generally, the plastic lenses are very susceptible to scratching.

In order to improve scratch resistance, a hard coat layer formed of a thermosetting silicone, a ultraviolet-curable acrylic or the like is usually formed on the surface of the lens substrate (see, for example, Japanese Unexamined Patent Application Publication No. 08-198985).

Further, in order to suppress surface-reflection (which causes flicker of image), an antireflection film is further formed on the hard coat layer by, for example, vacuum-depositing an inorganic material.

Furthermore, a layer for preventing water spotting may be formed according to necessity.

However, if the hard coat layer is formed of the thermosetting silicone, since curing time of the thermosetting silicone is one hour or more, large-scale equipment is required, and which is a demerit.

Further, if the hard coat layer is formed of the ultraviolet-curable acrylic, although curing time can be reduced, good scratch resistance and weather resistance can not be obtained, so that the ultraviolet-curable acrylic is unsuitable to be used for forming a hard coating film for spectacle lens.

To solve these problems, an improved ultraviolet-curable acrylic silicone hard coat has been developed whose hardness is close to that of the thermosetting silicone and therefore has excellent scratch resistance.

### SUMMARY OF THE INVENTION

However, the aforesaid improved ultraviolet-curable acrylic silicone hard coat has no good weather resistance, and further, it is difficult to obtain good adhesion to the antireflection film formed of inorganic material.

Further, since the acrylic compound is cured by ultraviolet radical polymerization, the curing process needs to be performed under an inert condition, and therefore large-scale equipment is required.

To solve these problems, it is an object of the present invention to provide a coating composition for optical member capable of forming a coat layer having good scratch resistance and weather resistance in a short time, a manufacturing method thereof, and a manufacturing method of an optical member manufactured using the coating composition.

A coating composition for optical member according to an aspect of the present invention is to be coated on an optical member. The coating composition includes: an epoxy group-containing compound; a photocationic polymerization initiator; an organic solvent; and inorganic particulates dispersed in the organic solvent.

A method for manufacturing a coating composition for optical member according to another aspect of the present invention includes the steps of: hydrolyzing an epoxy group-containing compound having an organosilane contained in part thereof; and adding inorganic particulates and an organic solvent into the epoxy group-containing compound containing a hydrolysate of organosilane and stirring the result.

A method for manufacturing an optical member according to further another aspect of the present invention includes the steps of: coating the aforesaid coating composition for optical member on a substrate of the optical member; and curing the coated coating composition by irradiating ultraviolet light to form a hard coat layer.

With the configuration of the coating composition for optical member according to the present invention, by containing the epoxy group-containing compound, the photocationic polymerization initiator, the organic solvent, and the inorganic particulates dispersed in the organic solvent, the coating composition can be cured in a short time by irradiating ultraviolet light. Further, the cured material has high transparency.

Further, since the epoxy group-containing compound is used, not only a hard coat layer having excellent scratch resistance and weather resistance can be formed, but also adhesion to the antireflection film formed of inorganic material can be improved, compared with the ultraviolet-curable acrylic hard coat.

Thus, by using the coating composition for optical member according to the present invention, the hard coat layer having good scratch resistance can be formed by curing in a short time, and further, sufficient adhesion to the antireflection film formed of inorganic material can be obtained.

According to the method for manufacturing the coating composition for optical member of the present invention, the step of hydrolyzing the epoxy group-containing compound having the organosilane contained in part thereof is performed first, and then the step of adding the inorganic particulate and the organic solvent into the epoxy group-containing compound containing a hydrolysate of organosilane (which is obtained in the hydrolyzing step) and stirring the result is performed. By previously hydrolyzing the organosilane, the hydrophilicity of the coating composition is improved, and therefore wettability of the coating composition can be improved when being coated on the optical member, so that homogeneous coating film can be formed on the optical member.

The hydrolysis process of the organosilane may also be omitted. In such a case, since the hydrolysis process is eliminated, time for performing the hydrolysis process can be saved and manufacturing complexity caused by liquid reaction control can be reduced, so that the coating composition can be prepared easily in a short time.

According to the method for manufacturing an optical member of the present invention, since the hard coat layer is formed by coating the coating composition for optical member on the substrate and curing the coated film by irradiating ultraviolet light, the coating composition can be cured in a short time to form a hard coat layer having good scratch resistance and weather resistance.

Further, in the case where an antireflection film made of inorganic material is formed on the hard coat layer, sufficient adhesion to the antireflection film can be obtained.

Thus, according to the present invention, it is possible to obtain a coating composition which has excellent scratch resistance, excellent weather resistance and excellent adhesion to both the optical member and antireflection film, and to obtain an optical member having a hard coat layer formed of the coating composition.

### DETAILED DESCRIPTION OF THE PREFERRED EMBODIMENT(S)

A coating composition for optical member according to the present invention contains an epoxy group-containing compound, a photocationic polymerization initiator, an organic solvent, and inorganic particulates dispersed in the organic solvent.

Examples of the epoxy group-containing compound contained in the coating composition for optical member according to the present invention include silane compounds, epoxy compounds and the like. Examples of the silane compounds include glycidoxymethyl triethoxysilane, α-glycidoxyethyl triethoxysilane, β-glycidoxyethyl trimethoxysilane, β-glycidoxyethyl triethoxysilane, α-glycidoxypropyl trimethoxysilane, α-glycidoxypropyl triethoxysilane, β-glycidoxypropyl trimethoxysilane, β-glycidoxy propyl triethoxysilane, γ-glycidoxypropyl trimethoxysilane, γ-glycidoxypropyl triethoxysilane, γ-glycidoxypropyl tripropoxysilane, γ-glycidoxypropyl tributoxysilane, γ-glycidoxypropyl triphenoxysilane, α-glycidoxybutyl trimethoxysilane, α-glycidoxybutyl triethoxysilane, β-glycidoxybutyl trimethoxysilane, β-glycidoxybutyl triethoxysilane, γ-glycidoxybutyl trimethoxysilane, glycidoxybutyl triethoxysilane, δ-glycidoxybutyl trimethoxysilane, δ-glycidoxybutyl triethoxysilane, (3,4-epoxycyclohexyl)methyl trimethoxysilane, (3,4-epoxycyclohexyl)methyl triethoxysilane, β-(3,4-epoxycyclohexyl)ethyl trimethoxysilane, β-(3,4-epoxycyclohexyl)ethyl triethoxysilane, β-(3,4-epoxycyclohexyl)ethyl tripropoxysilane, β-(3,4-epoxycyclohexyl)ethyl tributoxysilane, β-(3,4-epoxycyclohexyl)ethyl triphenoxysilane, γ-(3,4-epoxycyclohexyl)propyl trimethoxysilane, γ-(3,4-epoxycyclohexyl)propyl triethoxysilan, δ-(3,4-epoxycyclohexyl)butyl trimethoxysilane, δ-(3,4-epoxycyclohexyl)butyl triethoxysilane, glycidoxymethyl methyl dimethoxysil, glycidoxymethyl methyl diethoxysilane, α-glycidoxyethyl methyl dimethoxysilane, α-glycidoxyethyl methyl diethoxysilane, β-glycidoxyethyl methyl dimethoxysilane, β-glycidoxyethyl methyl diethoxy, α-glycidoxypropyl methyl dimethoxysilane, α-glycidoxypropyl methyl diethoxysilane, β-glycidoxypropyl methyl dimethoxysilane, β-glycidoxypropyl methyl diethoxysilane, γ-glycidoxypropyl methyl dimethoxysilane, γ-glycidoxypropyl methyl diethoxysilane, γ-glycidoxypropyl methyl dipropoxysilane, γ-glycidoxypropyl methyl dibutoxysilane, γ-glycidoxypropyl methyl diphenoxysilane, γ-glycidoxypropyl ethyl dimethoxysilane, γ-glycidoxypropyl ethyl diethoxysilane, γ-glycidoxypropyl vinyl dimethoxysilane, γ-glycidoxypropyl vinyl diethoxysilane, γ-glycidoxypropyl phenyl dimethoxysilane, γ-glycidoxypropyl phenyl diethoxysilane and the like. Examples of the epoxy compounds include sorbitol polyglycidyl ether, polyglycerol polyglycidyl ether, pentaerythritol polyglycidyl ether, diglycerol polyglycidyl ether, diglycerol polyglycidyl ether, trimethylolpropane polyglycidyl ether, resorcinol diglycidyl ether, neopentyl glycol diglycidyl ether, 1,6-hexanediol diglycidyl ether, hydrogenated bisphenol A diglycidyl ether, ethylene-polyethylene glycol diglycidyl ether, propylene-polypropylene glycol diglycidyl ether, allyl glycidyl ether, 2-ethylhexyl glycidyl ether, phenyl glycidyl ether, phenol(EO)5 glycidyl ether, p-tert-butylphenyl glycidyl ether, lauryl alcohol(EO)15 glycidyl ether, polybutadiene diglycidyl ether and the like.

Incidentally, any one of an organosilane, a hydrolysate of organosilane and a partial condensate of organosilane may be contained in part of the epoxy group-containing compound.

Examples of the photocationic polymerization initiator contained in the coating composition for optical member include benzyltriphenyl phosphonium hexafluorophosphate, benzylpyridium hexafluorophosphate, diphenyliodonium hexafluorophosphate, triphenylsulfonium hexafluorophosphate, benzoin tosylate and the like.

Content of the photocationic polymerization initiator based on the total amount of epoxy monomer composition is in a range of 0.1-5.0% by weight, preferably in a range of 0.5-3.0% by weight.

Examples of the inorganic particulates contained in the coating composition for optical member include silicon oxide (silica), titanium oxide (titania), zirconium oxide (zirconia), aluminum oxide (alumina), iron oxide, antimony oxide, tin oxide, tungsten oxide, and their composite products. Among these compounds, silicon oxide, titanium oxide, zirconium oxide are preferably used.

The material of the inorganic particulates is selected according to refractive index of the optical member substrate. For example, silica, which has low refractive index, may be selected as the material of the inorganic particulates if the substrate is formed of allyl diglycol carbonate, which has low refractive index. Further, zirconia, titania or the like, which has high refractive index, may be selected as the material of the inorganic particulates if the substrate is formed of a thiourethane-based resin, an episulfide-based resin or the like, which has high refractive index.

It is preferred that the inorganic particulates contained in the coating composition are colloidally dispersed, so that uneven distribution of the inorganic particulates in the coating film can be inhibited.

Examples of the organic solvent for dispersing the inorganic particulates contained in the coating composition for optical member include methyl ethyl ketone, propylene glycol monomethyl ether, ethylene glycol mono-n-propyl ether and the like.

Incidentally, if solvent such as methanol, isopropyl alcohol or the like is used, use time in liquid state (pot life) will become very short. For this reason, if such solvent is used, it is preferred that the coating composition is coated in a rapid manner after the coating composition is prepared by mixing the respective materials.

In contrast, if a ketone-based organic solvent or cellosolve-based organic solvent is used, sufficient use time in liquid state (pot life) can be ensured.

With the configuration of the coating composition for optical member according to the present invention, by containing the epoxy group-containing compound, the photocationic polymerization initiator, the organic solvent, and the inorganic particulates dispersed in the organic solvent, the coating composition can be cured in a short time by irradiating ultraviolet light. Further, the cured material has high transparency.

Further, since the epoxy group-containing compound is used, not only a hard coat layer having good scratch resistance and weather resistance can be formed, but also adhesion to the antireflection film formed of inorganic material can be improved, compared with the conventional ultraviolet-curable acrylic hard coat.

Thus, by using the coating composition for optical member according to the present invention, the coating composition can be cured in a short time to form a hard coat layer which has good scratch resistance, good weather resistance, and good adhesion to the antireflection film formed of inorganic material.

The method for manufacturing the coating composition for optical member according to the present invention includes the steps of: hydrolyzing the epoxy group-containing compound having an organosilane contained in part thereof, and adding the inorganic particulates and the organic solvent into the epoxy group-containing compound containing a hydrolysate of the organosilane and stirring the resultant mixture.

The method for manufacturing the optical member according to the present invention includes the steps of: coating the coating composition for optical member according to the present invention (i.e., the coating composition containing the epoxy group-containing compound, the photocationic polymerization initiator, the organic solvent, and the inorganic particulates dispersed in the organic solvent) on the substrate, and curing the coated coating composition by irradiating ultraviolet light to form the hard coat layer.

When performing the curing process by ultraviolet irradiation after the coating composition has been coated, the irradiation time of the ultraviolet light is preferably in a range from 1 second to 120 seconds, more preferably in a range from 15 seconds to 60 seconds. If the irradiation time is shorter than 1 second, the curing of the coating composition will be insufficient; and if the irradiation time is longer than 120 seconds, the plastic substrate will be susceptible to yellowing.

The coating composition is usually coated on the substrate by dipping method, spin-coating method, spraying method and the like. Among these methods, dipping method and spin-coating method are preferably used to achieve high surface accuracy.

Incidentally, it is also possible to perform a chemical treatment, a physical treatment and a cleaning treatment before the coating composition is coated on the substrate. The perform chemical treatment can be performed with acid, alkali and/or various organic solvents; the physical treatment can be performed with plasma, ultraviolet irradiation and/or the like; and the cleaning treatment can be performed with various detergents.

The thickness of the hard coat layer formed by curing the coating film with ultraviolet irradiation is in a range of 0.5-10 μm, preferably in a range of 1-5 μm. If the thickness of the hard coat layer is less than 1 μm, improvement of scratch resistance will be insufficient; and if the thickness of the hard coat layer is more than 10 μm, the hard coat layer will be susceptible to cracking.

Although the substrate to which the coating composition for optical member of the present invention can be applied and the substrate forming the optical member of the present invention may be made of glass, however it is particularly preferred that these substrates are made of plastic such as synthetic-resin and the like.

Examples of the material of the plastic substrate include but not limited to: copolymer of methyl methacrylate and at least one other monomer, copolymer of diethylene glycol bisallyl carbonate and at least one other monomer, polycarbonate, polystyrene, polyvinyl chloride, unsaturated polyester, polyethylene terephthalate, polyurethane, polythiourethane, sulfide resin obtained by utilizing an ene-thiol reaction, sulfur-containing vinyl polymer and the like.

With the method for manufacturing the optical member according to the present invention, since the hard coat layer is formed by coating the coating composition for optical member on the substrate and curing the coating film by irradiating ultraviolet light, the coating composition can be cured in a short time to form a hard coat layer having good scratch resistance and weather resistance.

Further, in the case where an antireflection film made of inorganic material is formed on the hard coat layer, sufficient adhesion to the antireflection film can be obtained.

In the method for manufacturing the optical member of the present invention, it is possible to further form an antireflection film on the hard coat layer.

Construction of the antireflection film is not particularly limited. The antireflection film may have a single or multi-layered construction formed by a known inorganic oxide.

The multi-layered antireflection film may have a construction in which SiO₂ film and ZrO₂ film are alternately stacked to form a structure of λ/4-λ/2-λ/4, where λ represents wavelength of incident light.

Since the hard coat layer, which is formed by coating and curing the coating composition for optical member according to the present invention, has good adhesion to the antireflection film formed of inorganic material, the antireflection film can be formed with good adhesion.

### EXAMPLES

Examples of the present invention are concretely described below, and it should be understand that the present invention is not limited to these examples.

### Example 1

### (Prepare Hard Coating Liquid)

As the inorganic particulates, 152 parts by mass of a methyl ethyl ketone dispersed colloidal silica sol (solid content: 30%; manufactured by Nissan Chemical Industries, Ltd.) was added into a glass container having a magnetic stirrer, and further, 60 parts by mass of an epoxy group-containing organosilicon compound of γ-glycidoxy propyl trimethoxysilane (trade name: KBM403; manufactured by Shin-Etsu Chemical Co., Ltd.) was dropped with stirring.

After dropping of the epoxy group-containing organosilicon was completed, 90 parts by mass of propylene glycol monoethyl ether (as solvent), 0.3 parts by mass of silicone surfactant, and 2 parts by mass of a photocationic polymerization initiator (trade name: SP150; manufactured by Asahi Denka kogyo Co., Ltd.) were added and then, after sufficient stirring, filtered so that the hard coating composition is obtained.

### (Coating and Curing)

Diethylene glycol bisallyl carbonate (trade name: HL; manufactured by HOYA Corporation; center thickness: 2.0 mm) was used as the substrate of the plastic lens, and the substrate was immersed in a 10% aqueous sodium hydroxide solution at 45° C. for 5 minutes, and then sufficiently dried.

Thereafter, the hard coating composition prepared by the above method was coated on the substrate by dipping (drawing speed: 20 cm/min).

Further, the coated hard coating composition was irradiated by ultraviolet for 30 seconds to be cured, so that a transparent hard coat layer was formed.

### (Form Antireflection Film)

An antireflection film was formed on the plastic lens having the hard coat layer formed thereon in a manner described below.

The plastic lens with the hard coat layer formed thereon was set into a vapor-deposition apparatus, and heating and exhausting were started until the temperature reached 85° C. and the pressure reached 2×10⁻⁵ Torr, and then material of the antireflection film was vapor-deposited by electron-beam heating method to form the antireflection film having a stacked structure (λ/4-λ/2-λ/4; λ represents wavelength) of SiO₂ and ZrO₂.

In such a manner, the plastic lens was manufactured as a sample of Example 1.

### Example 2

The plastic lens sample of Example 2 was manufactured in the same manner as that of Example 1 except that the colloidal silica in the hard coating composition of Example 1 was changed to ethylene glycol mono-n-propyl ether dispersed colloidal silica sol (solid content: 30%; manufactured by Nissan Chemical Industries, Ltd.).

### Example 3

### (Prepare Hard Coating Liquid)

60 parts by mass of an epoxy group-containing organosilicon compound of γ-glycidoxy propyl trimethoxy silane (trade name: KBM403; manufactured by Shin-Etsu Chemical Co., Ltd.) was added in a glass container having a magnetic stirrer, and 15 parts by mass of 0.1 N hydrochloric acid was dropped with stirring, and the stirring was continued at 5° C. for 24 hours.

After 24 hours had elapsed, 152 parts by mass of a methyl ethyl ketone dispersed colloidal silica sol (solid content: 30%; manufactured by Nissan Chemical Industries, Ltd.) was dropped as the inorganic particulates with stirring.

After dropping of the methyl ethyl ketone dispersed colloidal silica sol was completed, 90 parts by mass of propylene glycol monoethyl ether (as solvent), 0.2 parts by mass of a silicone surfactant, and 2 parts by mass of a photocationic polymerization initiator (trade name: SP150; manufactured by Asahi Denka kogyo Co., Ltd.) were added and then, after sufficient stirring, filtered so that the preparation of the hard coating composition is completed.

Coating and curing process was performed in the same manner as Example 1, so that the plastic lens was manufactured as a sample of Example 3.

### Example 4

The plastic lens sample of Example 4 was manufactured in the same manner as that of Example 3 except that the colloidal silica in the hard coating composition of Example 3 was changed to an ethylene glycol mono-n-propyl ether emulsion of colloidal silica sol (solid content: 30%; manufactured by Nissan Chemical Industries, Ltd.).

### Comparative Example 1

The plastic lens sample of Comparative Example 1 was manufactured in the same manner as that of Example 1 except that 2 parts by mass of the photocationic polymerization initiator of Example 1 was changed to 3 parts by mass of a thermal polymerization initiator of acetylacetonatoaluminum, and that curing means was changed from ultraviolet irradiation of Example 1 to hot air of 120° C.

### Comparative Example 2

The plastic lens sample of Comparative Example 2 was manufactured in the same manner as Example 1 except that the hard coating composition of Example 1 was changed to an ultraviolet-curable urethane acrylate hard coating composition formed by tolylene diisocyanate and 1-hydroxyethyl acrylate.

### Comparative Example 3

The plastic lens sample of Comparative Example 3 was manufactured in the same manner as that of Example 1 except that the colloidal silica in the hard coating composition of Example 1 was changed to a methyl alcohol dispersed colloidal silica sol (solid content: 30%; manufactured by Nissan Chemical Industries, Ltd.).

### Comparative Example 4

The plastic lens sample of Comparative Example 4 was manufactured in the same manner as that of Example 1 except that the colloidal silica in the hard coating composition of Example 1 was changed to an isopropyl alcohol dispersed colloidal silica sol (solid content: 30%; manufactured by Nissan Chemical Industries, Ltd.).

### <Measurement of Properties>

The following test methods were used to measure properties of plastic lens samples of the respective examples and comparative examples.

### (1) Scratch Resistance Test

A scratch resistance test was performed using steel wool (#0000, manufactured by Nippon Steel Wool Co., Ltd.) to rub the surface of the plastic lens under a load of 1 kgf/cm², and the test result was visually evaluated to judge how difficult the scratch was formed in the surface. Evaluation criteria of the scratch resistance test are described below.

A. Almost no scratch is formed even when rubbing strongly.

B. Scratches are formed when rubbing strongly.

C. Scratches are formed as easily as a plastic substrate.

The plastic lenses were respectively manufactured both in a condition where the coating composition was coated immediately after the coating liquid had been prepared and in a condition where the coating composition was coated after 24 hours had elapsed since the coating liquid had been prepared for each of the examples and comparative examples, and scratch resistance test was performed on each of the plastic lenses.

### (2) Adhesion Test (Crosshatch Test)

100 crosshatch-cuts were formed at an interval of 1 mm, and an adhesive tape (trademark “CELLOTAPE”, manufactured by Nichiban Co., Ltd.) was closely adhered to the cross-hatched surface and then immediately peeled off to check whether the cut cured films were peeled off.

The test results were rated from 100/100 (which means no cut cured film was peeled off) to 0/100 (which means all cut cured films were peeled off).

### (3) Appearance

Appearance of the lens was visually judged under fluorescent light in a dark room.

### (4) Bayer Test (Abrasion Resistance Test)

Bayer value was calculated based on haze value change of standard lenses and haze value change of the lenses to be measured (the sample lenses), using an abrasion tester BTM™@Abrasion Tester (manufactured by Colts Laboratories, USA) and a haze meter (manufactured by Murakami Color Research Laboratory).

Sample number and concrete measuring method are described below.

(i) Three standard lenses (CR39 substrate; diethylene glycol bisallyl carbonate) and three sample lenses are prepared.

(ii) Haze value was measured before performing the abrasion test.

(iii) The abrasion test was performed on each of the standard lenses and sample lenses using the abrasion tester. In the abrasion test, the lens was rubbed back and forth with sand for 600 times to abrade the surface thereof.

(iv) Haze value was measured after performing the abrasion test.

(v) Bayer value was calculated (average value of the three lenses).

Herein, “Bayer value” means: (haze value change<difference>the standard lenses)/(haze value change<difference>of the sample lenses). The greater the Bayer value is, the smaller the haze value change of the sample lenses is (i.e., the greater the abrasion resistance of the sample lenses is).

Incidentally, the Bayer test was performed on the samples of Example 1 and Example 3 only, and the samples were subjected to the Bayer test in a stage where the hard coat layer had been formed but the antireflection film had not been formed yet.

Other tests were performed on the samples after the antireflection film was formed.

The results of items (1) to (3) for each of the examples and comparative examples and the results of item (4), i.e., the Bayer test, for Examples 1 and 3 are shown in Table 1.

TABLE 1

| | Scratch Resistance | | | | | Treatment |
|---|---|---|---|---|---|---|
| | immediately | 24 hr later | Bayer Test | Adhesion | Appearance | Time |
| Example 1 | A | A | 3.8 | 100/100 | good | 30 sec |
| Example 2 | A | A | — | 100/100 | good | 30 sec |
| Example 3 | A | A | 3.8 | 100/100 | good | 30 sec |
| Example 4 | A | A | — | 100/100 | good | 30 sec |
| Comp. Ex. 1 | C | C | — | 100/100 | good | 30 sec |
| Comp. Ex. 2 | B | B | — | 50/100 | good | 30 sec |
| Comp. Ex. 3 | C | C | — | 100/100 | good | 30 sec |
| Comp. Ex. 4 | A | C | — | 100/100 | good | 30 sec |

It can be known from Table 1 that all test results for the samples of Examples 1 to 4 are good. In other words, all these samples have good scratch resistance and good adhesion to the antireflection film. It also can known that good scratch resistance can be obtained even when the coating composition is coated after 24 hours has elapsed since the coating liquid is prepared, which means that the coating composition has sufficient pot life and weather resistance.

In the sample of Comparative Example 1, since the curing means was changed from the ultraviolet curing to the hot air curing using the coating composition thermal polymerization initiator, the curing treatment time of 30 seconds (which was the same curing treatment time for performing the ultraviolet curing) was not enough to sufficiently cure the coated film, and therefore sufficient scratch resistance was not obtained.

In the sample of Comparative Example 2, the hard coating composition of Example 1 was changed to the ultraviolet-curable urethane acrylate hard coating composition, and good scratch resistance and good adhesion to the antireflection film were not obtained.

In the sample of Comparative Example 3, the colloidal silica of Example 1 was changed to methyl alcohol dispersed colloidal silica, and good scratch resistance was not obtained.

In the sample of Comparative Example 4, the colloidal silica of Example 1 was changed to the isopropyl alcohol dispersed colloidal silica. In Comparative Example 4, good scratch resistance was obtained when the hard coating composition was coated immediately after the coating liquid was prepared, but good scratch resistance was not obtained when the hard coating composition was coated after 24 hours had elapsed since the coating liquid had been prepared. In other words, pot life of the coating composition of Comparative Example 4 is short.

The Bayer test was performed on Example 1 and Example 3 only, and good results of 3.8 were obtained for all samples.

Thus, as can be known from Examples 1 to 4, it is possible to obtain a hard coating composition having good scratch resistance, good weather resistance and good adhesion to the antireflection film by containing the epoxy group-containing compound and the photocationic polymerization initiator.

It is to be understood that the present invention is not limited to the embodiments described above, but may have various other configurations without departing from the spirit and scope of the present invention.

What is claimed is:

1. A coating composition for optical member to be coated on an optical member, comprising:
an epoxy group-containing compound;
a photocationic polymerization initiator;
an organic solvent; and
inorganic particulates dispersed in the organic solvent.

2. The coating composition for optical member according to claim 1, wherein the inorganic particulates are colloidally dispersed.

3. The coating composition for optical member according to claim 1 or 2, wherein the organic solvent is a cellosolve-based solvent or a ketone-based solvent.

4. The coating composition for optical member according to claim 1 or 2, wherein any one of an organosilane, a hydrolysate of organosilane and a partial condensate of organosilane is contained in part of the epoxy group-containing compound.

5. The coating composition for optical member according to claim 3, wherein any one of an organosilane, a hydrolysate of organosilane and a partial condensate of organosilane is contained in part of the epoxy group-containing compound.

6. A method for manufacturing a coating composition for optical member comprising the steps of:
hydrolyzing an epoxy group-containing compound having an organosilane contained in part thereof; and
adding inorganic particulates and an organic solvent into the epoxy group-containing compound containing a hydrolysate of the organosilane and stirring the result.

7. A method for manufacturing an optical member comprising the steps of:
coating a coating composition on a substrate of the optical member, the coating composition containing an epoxy group-containing compound, a photocationic polymerization initiator, an organic solvent, and inorganic particulates dispersed in the organic solvent; and
curing the coated coating composition by irradiating ultraviolet light to form a hard coat layer.

8. The method for manufacturing the optical member according to claim 7, further comprising the step of: forming an antireflection film on the hard coat layer.
